(19) United States
(12) Patent Application Publication
(10) Pub. No.: US 2021/0179036 A1
(43) Pub. Date: Jun. 17, 2021

(54) ACTIVE AIR SCOOP

(71) Applicant: Faraday&Future Inc., Gardena, CA (US)

(72) Inventors: Khiem Bao Dinh, Hawthorne, CA (US); Sergio Gonzalez, San Fernando, CA (US)

(21) Appl. No.: 16/081,409

(22) PCT Filed: Mar. 1, 2017
(86) PCT No.: PCT/US2017/020267

§ 371 Date: Aug. 30, 2018

Related U.S. Application Data
(60) Provisional application No. 62/301,955, filed on Mar. 1, 2016.
(60) Provisional application No. 62/353,950, filed on Jun. 23, 2016.

(51) Int. Cl. B60T 5/00; F16D 65/78

(52) U.S. Cl. CPC B60T 5/00; F16D 2065/783; F16D 65/78

(57) ABSTRACT

An air duct system for a vehicle including at least one active air scoop configured to control air flow to the wheel wells of a vehicle. In some examples, the active air scoop can be positioned at the underbody of the vehicle. In some examples, the air duct system can include a first and second branch directing air to first and second areas of the wheel well. In some examples, the amount of air directed to the first and second branch are controlled by the active scoop and/or one or more valves in the air duct. In some examples, the active air scoop can be controlled based on one or more temperature measurements in the wheel well.

### FIELD OF THE DISCLOSURE

The present application relates generally to vehicle air ducts, and more specifically to devices for actively regulating air flow to areas in a vehicle wheel well.

### SUMMARY

The present disclosure is directed to air duct systems for a vehicle, which can include active air scoops. An air duct system for a vehicle can include one or more ducts capable of directing air to a wheel well of a vehicle, and an active air scoop positioned at an inlet of the duct. The air scoop can be configured to control the amount of air flow to the inlet. In some configurations, the air duct can include one or more outlets to the wheel well, including outlets to a low-pressure area of a wheel well and brake components of the vehicle.

In some cases, the air duct system can include two or more active air scoops. In some examples, each air scoop can independently control air flow to a respective air duct. In other cases, a single active air scoop can control air flow to two or more branches of a duct (e.g., based on how open the air scoop is). In some cases, the air scoop can sit flush against the underbody of the vehicle when in a closed position. The air duct system can also include one or more valves within an air duct configured to direct the air flow to one or more branches within the duct.

In some examples, the operation of one or more active air scoops can be controlled based on the determined temperature in the respective wheel well associated with an active air scoop. For example, an air scoop can be configured to stay open only long enough to cool brake components of a vehicle, but then close when not needed in order to improve aerodynamic efficiency.

### BRIEF DESCRIPTION OF THE DRAWINGS

It should be noted that the drawing figures may be in simplified form and might not be to scale. In reference to the disclosure herein, for purposes of convenience and clarity only, directional terms, such as top, bottom, left, right, up, down, over, above, below, beneath, rear, front, distal, and proximal are used with respect to the accompanying drawings. Such directional terms should not be construed to limit the scope of the disclosure in any manner.

FIG. 1 is a front view of a vehicle illustrating a stagnation region according to various embodiments.

FIG. 2 is a schematic drawing of an underside of a vehicle illustrating high and low pressure areas according to various embodiments.

FIG. 3 is a schematic drawing of an underside of a vehicle illustrating high and low pressure areas according to various embodiments.

FIG. 4 is a schematic drawing of a portion of a vehicle and a duct according to various embodiments.

FIG. 5 is a schematic diagram of a portion of a vehicle and a duct according to various embodiments.

FIG. 6 is a schematic diagram of a portion of a vehicle and a duct according to various embodiments.

FIG. 7 is a schematic diagram of a portion of a vehicle and a duct according to various embodiments.

FIG. 8 is a schematic diagram of a portion of a vehicle and a duct according to various embodiments.

FIG. 9 is a schematic drawing of a side view of a vehicle illustrating an active air scoop in a fully extruded positon.

FIG. 10 is a schematic drawing of the underbody of a vehicle illustrating a location of an active air scoop.

FIG. 11 is a schematic drawing of a side view of a portion of a vehicle depicting an active air scoop, ducting, and wheel well.

FIG. 12 is a schematic drawing of a top view of a portion of vehicle depicting two active air scoops, ducting, and wheel well.

FIG. 13A is a schematic drawing of a top view of a portion of a vehicle depicting an active air scoop, ducting, and wheel well.

FIG. 13B is a schematic drawing of a top view of the portion of vehicle depicting an active air scoop, ducting, and wheel well shown in FIG. 13A.

FIG. 14 is a diagram of an exemplary controlled cooling system process.

### DETAILED DESCRIPTION

When a vehicle is in motion, a complex 3-dimensional system of air flow patterns is generated around the vehicle. The flow patterns can be generally grouped as flow past the front of the vehicle, flow over the sides and roof, flow in the gap between a bottom surface of the vehicle and the road, and flow behind the vehicle (wake). These air flow patterns can result in areas or zones of vastly different pressure surrounding the vehicle. Depending on the aerodynamics of the vehicle design, high pressure areas can resist forward movement of the vehicle, and low pressure areas can result in drag that results in forces acting in the direction of the air flow (opposite from the vehicle motion). Both of these resultant forces can either impede the performance of the vehicle, or in the design stage result in the choice of a larger engine to achieve desired performance. In a gasoline or diesel powered vehicle, the resultant forces can decrease the fuel mileage of the vehicle. In an electric vehicle, the resultant forces can decrease the range of the vehicle.

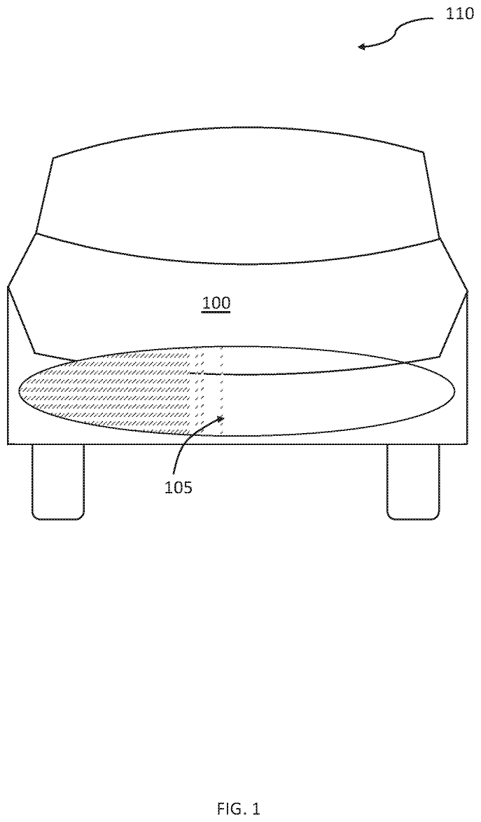

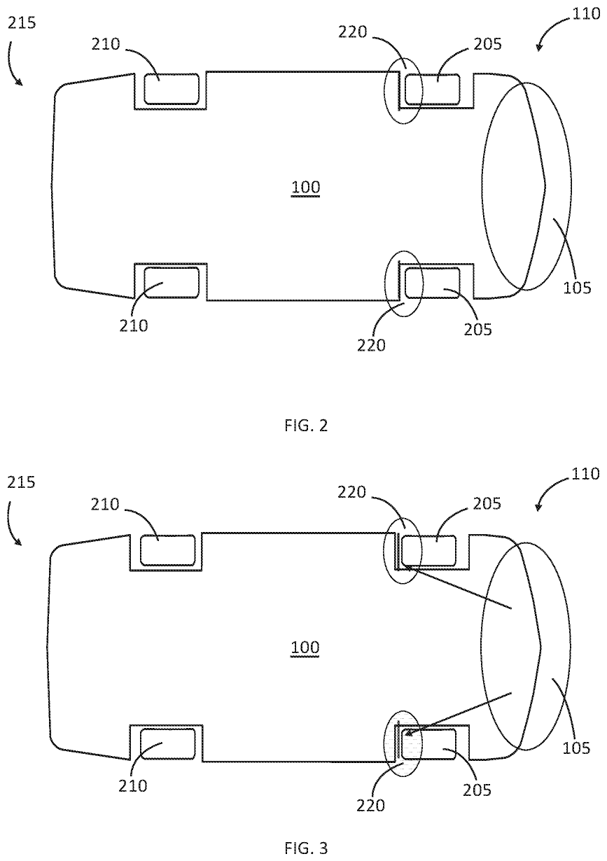

At the front of the moving vehicle, when there can be insufficient air flow to direct the air immediately in front of the vehicle around, over or under the vehicle, the velocity of the air can approach zero. At this point, the static pressure can reach a maximum value, referred to as the stagnation pressure. The area where stagnation pressure occurs is referred to as the stagnation region (see, for example, FIGS. 1 and 2). While drag can be most evident at the rear of the vehicle, drag also occurs behind each wheel due the location of the wheels in the air flow region under the vehicle. The blunt cross-sectional shape of the wheels, with respect to the air flow, can create a wake behind each wheel and can result in drag forces imposed on the vehicle. The combination of stagnation pressure at the front of the vehicle and drag behind each of the front wheels can result in a combination of forces detrimental to maintaining forward movement of the vehicle.

Additionally, in modern automotive design, wheel wells now house many thermal sinks that are placed there to bleed off excess energy in the form of heat. A non-exhaustive list of such thermal sinks includes: vehicle brakes, oil coolers, radiators, air conditioning heat exchangers, and battery coolant plates. The placement of these thermal sink components in a wheel well that experiences limited air flow can result in the formation of thermal micro climates surrounding individual thermal sinks. These micro climates may act to limit the designed efficiency of those thermal sinks and negatively affect the associated vehicle system.

Referring now to FIGS. 1 and 2, a vehicle 100 is illustrated according to various embodiments in a front view (FIG. 1) and a bottom view (FIG. 2). As the vehicle 100 is moving forward, a region of high pressure air can build at the front end 110 of the vehicle 100. Because of the relatively blunt shape of the front end 110, the region of high pressure air can be trapped leading to a stagnation region 105. At essentially the same time, as illustrated in FIG. 2, regions of low pressure 220 can be created behind each of the front wheels 205 (as used herein, the term “wheel” refers to the rim/tire combination) due to the turbulence created in the air flow around the non-aerodynamic cross-sectional shape of the front wheels 205. Although generally to a lesser extent, low pressure regions can be created behind each of the rear wheels 210 as well as just behind the back end 215 of the vehicle 100.

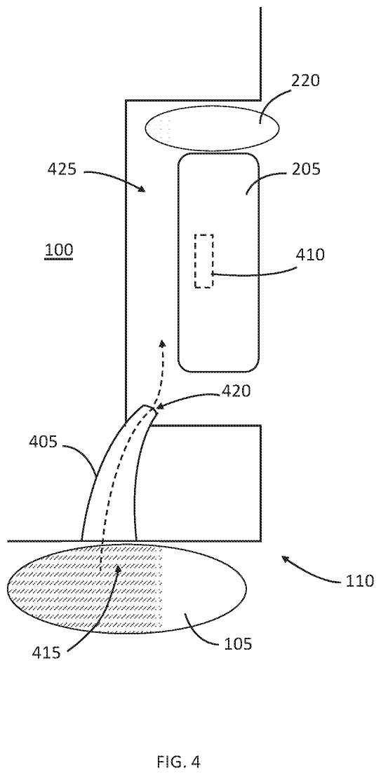

As illustrated by the arrows in FIG. 3, according to various embodiments, the undesirable forces resulting from the stagnation region 105 and the regions of low pressure 220 can be reduced or minimized by moving air from the stagnation region 105 to the regions of low pressure 220. Various configurations to move air from stagnation region 105 to regions of low pressure 220 are explained with reference to FIGS. 4-8 below. Additionally or alternatively, in other examples which will be explained with reference to FIGS. 10-14 below, the undesirable forces of low pressure 220 can be reduced or minimized by opening one or more active cooling scoops at the underbody of the vehicle. In all examples, the various configurations can also function to cool components within the wheel well, (e.g., the braking system), as will be explained further below.

FIG. 4 illustrates a portion of the front end 110 of the vehicle 100 according to various embodiments comprising a duct 405 extending from the front end 110 (e.g., from a front fascia) within the stagnation region 105 to the region of low pressure 220 behind the front wheel 205. The duct 405 can allow air to flow (as indicated by the dashed arrow) from the stagnation region 105 through a duct inlet 415 and into the duct 405, exiting the duct 405 out a duct outlet 420 into a wheel well 425. Removing air from the stagnation region 105 and injecting the air into the wheel well 425 can reduce the pressure of the stagnation region 105 thereby reducing the resistive force at the front end 110 of the vehicle 100. Injecting the air into the wheel well 425 can increase pressure within the wheel well 425 and reduce or minimize the region of low pressure behind the wheel 205 thereby reducing the drag force acting against the forward movement of the vehicle 100. In addition, as described in detail below, the air injected into the wheel well 425 by the duct 405 can have a beneficial effect of providing additional cooling to brakes 410.

The duct inlet 415 can comprise any shape conducive to non-turbulent flow of the air through the duct 405. As such, the duct inlet 415 can be round, oval, rectangular, and the like. The duct inlet 415 can be front facing, or it can be submerged (such as a NACA duct). Although not illustrated in FIG. 4, various embodiments can comprise a duct inlet 415 that extends across a large portion of the front end 110, or the duct inlet 415 can comprise multiple individual inlets 415 that join into the duct 405. Similarly, the duct outlet 420 can be any shape desired and can comprise one or more baffles (not shown) to direct the exiting air in more than one direction. As illustrated by the various embodiments of FIG. 4, the duct 405 can generally narrow from the inlet 415 to the outlet 420 to increase the velocity of the air at the outlet 420. However, one skilled in the art will readily recognize that the duct 405 can have a generally constant diameter, or cross-sectional area for non-circular ducts 405. Additionally, the overall shape of the duct 405 can be straight, curved, or any other complex geometry to pass through or around other components of the vehicle 100.

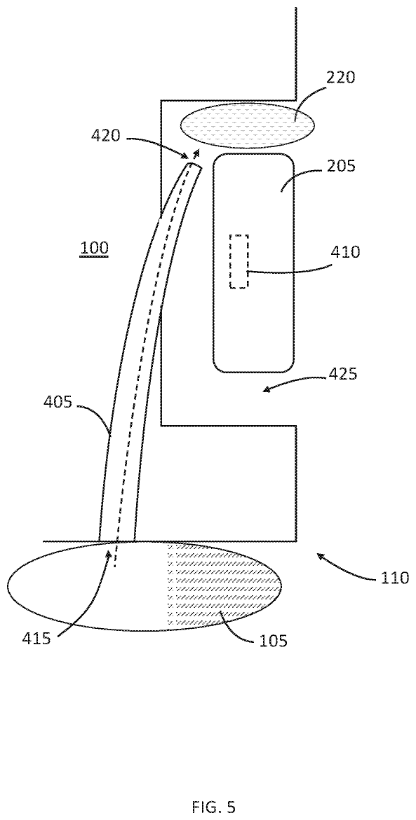

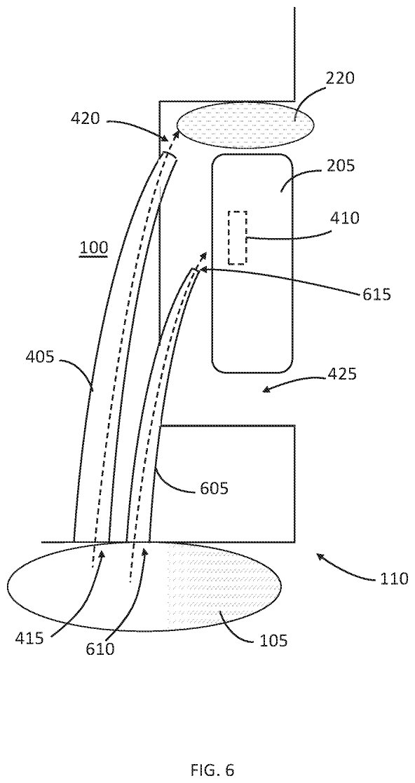

FIG. 5 illustrates various embodiments in which the duct 405 extends further into the wheel well 425 such that the duct outlet 420 is positioned in closer proximity to the region of low pressure 220. While the embodiments illustrated in FIG. 5 can more directly affect the region of low pressure, less air can be directed to the brakes 410 for cooling. Therefore, as illustrated in FIG. 6 according to various embodiments, a second duct 605 comprising a second inlet 610 and a second outlet 615 can be added to the vehicle 100. The second outlet 615 can be directed toward the brakes 410 to provide cooling.

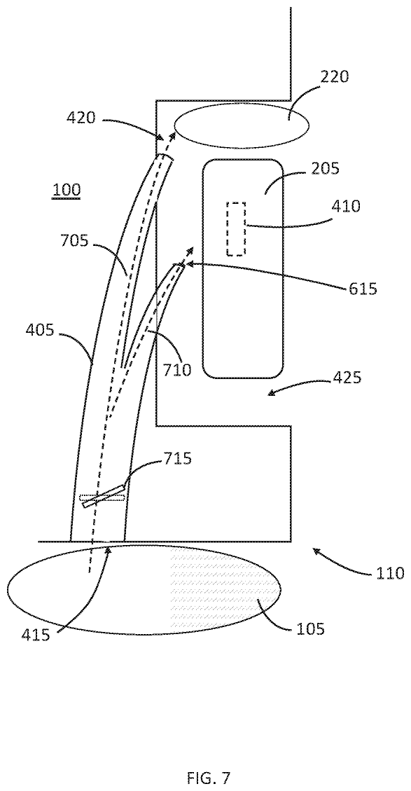

Depending on the structural design of the vehicle 100, routing the first and second ducts 405, 605 through the structure of the vehicle 100 to the wheel well 425 can prove challenging. Therefore, FIG. 7 illustrates various embodiments in which the duct 405 divides into a first branch 705 to direct a portion of the air flow to the region of low pressure 220 and a second branch 710 to direct a portion of the air flow to the brakes 410 for cooling. The branching of the duct 405 can occur at any point along a length of the duct 405 that is convenient for routing the duct 405 and the first and second branches 705, 710.

In various embodiments, the duct 405 can further comprise a valve 715 to regulate the air flow through the duct 405. The valve 715 can be moveable from a first position in which a maximum air flow is allowed through the duct, to a second position (shown in broken lines) in which the duct 405 is closed or nearly closed, or any position in between. Movement and positioning of the valve 715 can be controlled and directed by a system controller, which in turn can be in communication with an intelligent agent. The intelligent agent can be located within the vehicle 100 or external to the vehicle 100. In various embodiments, the system control can determine a position of the valve 715 based on input data from one or more sensors (not shown). Exemplary sensors can comprise, but are not limited to, pressure sensors located at any exterior point on the vehicle 100 or within the first or second duct 405, 605 or wheel well 425, temperature sensors in the brakes 410, ambient temperature sensors, speed sensors, throttle position sensors, and the like.

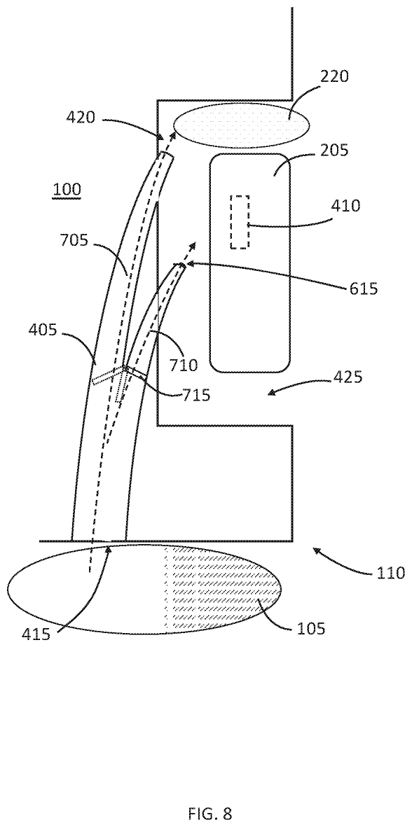

In various embodiments, the valve 715 can be positioned where the first and second branches 705, 710 extend from the duct 405 as illustrated in FIG. 8. As described above, the system controller can position the valve 715 based on sensor input data. For example, a temperature sensor within the brakes 410 can indicate that the brakes 410 are below an optimum operating temperature. In this situation, the system controller can direct the valve 715 to a position as shown in FIG. 8 that partially or completely closes the second branch 710, thereby allowing the temperature of the brakes 410 to rise. If the system controller later determines that the temperature of the brakes 410 is too high, then the valve 715 can be moved to a position as indicated by the broken lines in FIG. 8 to increase the air flow into the second branch 710.

The valve 715 can be a butterfly valve, a flapper valve, a ball valve, a disk valve, a shutter valve, a gate valve, a globe valve, or any other device known in the art to regulate fluid flow. The valve 715 can, for example, be electrically operated, or hydraulically operated.

In other examples, rather than directing airflow from front of air dam as described above with reference to FIGS. 2-8, air can be selectively directed to the areas within one or more wheel wells via one or more actuated active cooling scoops.

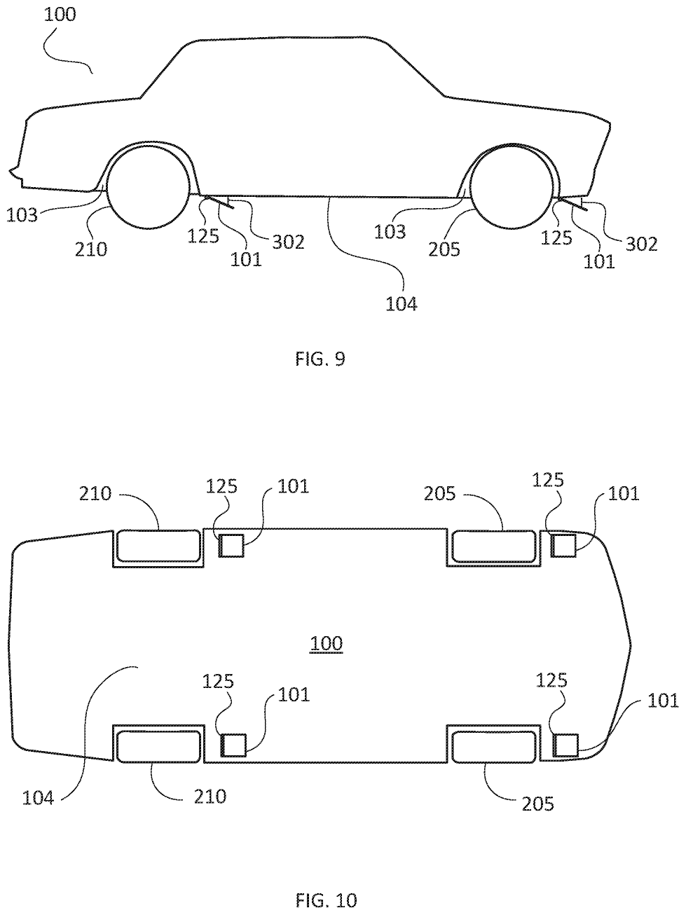

FIG. 9 depicts one embodiment of a vehicle with active cooling scoops 101. As with the above-described embodiments, an objective of the depicted system is to both limit drag forces on the vehicle and regulate the thermal environment of vehicle components located within a wheel well 103. FIG. 9 depicts the deployment of the active cooling scoops 101 to draw air into the vehicle wheel well 103 in order to cool the vehicle components located in that area. Although not shown in FIG. 9, the active cooling scoops may alternatively be in a closed position. In the closed position the active cooling scoops 101 can be positioned flush against the underbody of the vehicle, thus providing a low turbulence surface for air to pass over.

FIG. 10 depicts the underside of a vehicle according on an embodiment of this disclosure. The active cooling scoops 101 can be situated on the underbody panels 104 of a vehicle and may be situated slightly inboard of the centerline of each vehicle wheel 210, 205. In one embodiment by situating each active cooling scoop 101 slightly forward and to the inboard of each wheel 210, 205 a significant cooling advantage may be realized while creating the shortest cooling path for the active brake cooling system.

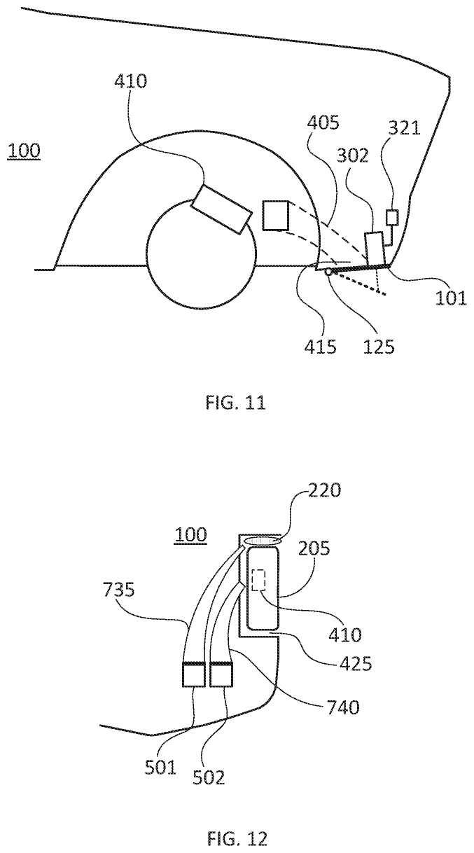

FIG. 11 depicts a detail view of a front wheel well and active cooling scoop according to one embodiment of the invention. For clarity, some elements such as wheel 205 are omitted. The active air scoop 101 is shown in a fully retracted position, with the fully open position indicated by the dotted lines. In one embodiment the active air scoop 101 is hinged at a pivot point on the side closest to the wheel 205 and when actuated it rotates radially along an axis horizontal to the underbody of the vehicle. This hinge 125 may include a spring that biases the movement of the active air scoop 101 toward a closed position. Such a spring may assist in the rapid closing of the active air scoop 101 when it is no longer necessary thus ensuring greater aerodynamic performance. In other embodiments hinge 125 may include a spring that biases the movement of the active air scoop 101 toward opening. In the biased opening embodiment, such a spring may assist in quicker opening of the active air scoop 101 for faster cooling.

The active cooling air scoop may be formed from the same material as the underbody of the vehicle. In some embodiments, it may be a pliable or flexible material which can be made of suitable materials to withstand weather and temperature extremes. Such materials include natural and synthetic polymers, various metals and metal alloys, naturally occurring materials, textile fibers, and all reasonable combinations thereof.

In further contemplated embodiments of the present disclosure, shape-changing or shape-shifting material can also be used in any of the embodiments. The shape-changing aspect of the disclosure is enabled by hardware comprised of motors and actuators governed by a vehicle dynamic control algorithm in a controller. Shape-changing or smart materials are materials that have one or more properties that can be significantly changed in a controlled fashion by external stimuli, such as stress, temperature, moisture, pH, electric or magnetic fields.

The active air scoops 101 are depicted with a fixed outer shape consisting of a flat planar bottom, a straight forward edge, and side walls forming a scoop or channel for air. In a separate contemplated embodiment, each active air scoop 101 has side walls that accordion down such that they form a continuous side wall from the bottom of the scoop to the vehicle underbody. That is, these airflow guiding pieces, each of which has a specific shape, and the pieces may retain their shape whether the pieces are deployed or retracted. In a further contemplated embodiment, any of these guiding pieces can be replaced or augmented by using pliable materials and underlying frames movable by actuators 302 which are governed by a controller 321. For instance, instead of using an underbody panel 104 made of rigid material, the underbody panel 104 is made of an underlying framework enveloped in the pliable material. By actively controlling the movement and shapes of the underlying frame, one can effectively change the outer contour of this particular underbody panel 104. The controller can also selectively change the location of the throat section by shifting the contraction fore or aft to modify aerodynamic distribution of front-to-rear wheel 210, 205 loading.

The active air scoop 101 can be moved using an actuator 302. The actuator 302 can, for example, be electrically operated, or hydraulically operated. In some embodiments, a rod or cable that is connected to an actuator 302, and used to move the active air scoop 101. Each actuator 302 may be configured to open the air scoop through a range of different angles. This opening angle may be selectively chosen to optimally balance the amount of cooling air allowed in while balancing the drag created by opening the active air scoop 101. At different times, each active air scoop 101 may be opened as required by the local thermal environment of the wheel well that active air scoop 101 is associated with.

In one contemplated embodiment, during a hard-turning brake event, the wheel wells 103 on the side facing away from the turn may be cooler and thus require less cooling. The active air scoops 101 on that side of the vehicle may be deployed at a shallow angle relative to the underbody of the car. Conversely the wheel wells 103 on the side of the vehicle closest to the turn may experience greater heat from heavier braking and require significant cooling. The active air scoops 101 may be deployed to a greater angle relative to the underbody of the car on that side. In an emergency braking scenario, high levels of heat may be generated or expected to be generated at all wheel wells 103. The active air scoops 101 in this situation may be deployed to their fullest deployable angle.

Further, movement and positioning of the active air scoop 101 can be controlled and directed by a system controller, which in turn can be in communication with an intelligent agent. The intelligent agent can be located within the vehicle 100 or external to the vehicle 100. In various embodiments, the system control can determine a position of the active air scoop 101 based on input data from one or more sensors (not shown). Exemplary sensors can comprise, but are not limited to, pressure sensors located at any location in the wheel well 103 on the vehicle underbody 104 or within the duct 405 on any thermal emitting component within the wheel well 103. These include thermal sensors on the vehicle brakes oil coolers, radiators, and the like.

Each active air scoop 101 is connected to its respective wheel well 103 via a duct 405. The duct inlet 415 can comprise any shape conducive to non-turbulent flow of the air through the duct 405. This duct inlet is communicatively coupled to the active air scoop 101 and the duct inlet 415 begins at the hinged side of the active air scoop 101. As such, the duct inlet 415 can be round, oval, rectangular, and the like. The duct inlet 415 is communicatively attached to the active air scoop 101. Although not illustrated in FIG. 4, various embodiments can comprise a duct inlet 415 that extends across a large portion of the active air scoop 101, or the duct inlet 415 can comprise multiple individual inlets 415 that join into the duct 405. Similarly, the duct outlet 420 can be any shape desired and can comprise one or more baffles (not shown) to direct the exiting air in more than one direction. In various embodiments, the duct 405 can generally narrow from the inlet 415 to the outlet 420 to increase the velocity of the air at the outlet 420. However, one skilled in the art will readily recognize that the duct 405 can have a generally constant diameter, or cross-sectional area for non-circular ducts 405. Additionally, the overall shape of the duct 405 can be straight, curved, or any other complex geometry to pass through or around other components of the vehicle 100.

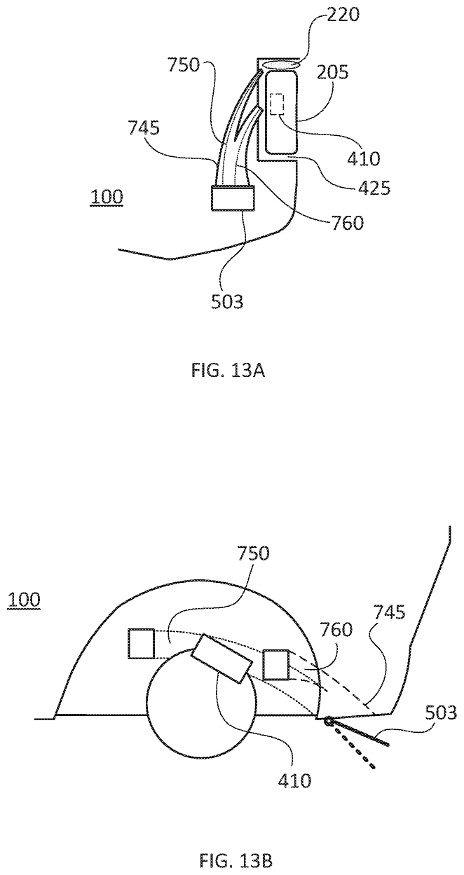

In some embodiments, duct 405 can extend further into the wheel well 103 such that the duct outlet 420 is positioned in closer proximity to the region of low pressure 220. In other embodiments, one or more ducts can be utilized to provide air to both brake rotors and region of low pressure 220. FIGS. 12-13 illustrate various embodiments in which the active air scoops are configured to selectively provide air to both a brake rotor and a region of low pressure.

FIG. 12 illustrates a top view of various embodiments in which a first duct 735 directs a portion of the air flow to the region of low pressure 220 and a second duct 740 directs a portion of the air flow to the brakes 410 for cooling, and air to either duct is determined by active air scoops 501 and 502. The configuration shown in FIG. 12 can operate similar to that shown in FIG. 6 above, however, here, the amount of air directed to low pressure 220 is controlled by a first air scoop 501, and the amount of air directed to brakes 410 is controlled by a second active air scoop 502.

FIG. 13A-13B illustrate a respective top view and side view of various embodiments in which an active air scoop 503 controls air flow into duct 745, which separates into a first branch 750 which can direct air to the region of low pressure 220, and a second branch 760, which can direct air to the brakes 410 for cooling. In these illustrations, air scoop 503 is shown in a first (partially opened) position, with a second (fully opened) position indicated in dotted lines. For clarity, wheel 205 is omitted from FIG. 13B. As illustrated in FIG. 13B, in some configurations, first branch 750 can be positioned above second branch 760 such that when air scoop 503 is opened to a first position, air is directed primarily to the first branch 750, and when air scoop 503 is opened to a second position (more open than the first position), air is also directed to the second branch 760. In other configurations not shown here, first and second branches 750 and 760 may be positioned horizontally with respect to one another. In these configurations, air scoop 503 may be configured to open more widely on one side than the other (e.g., via dual actuators at either vertical wall of the air scoop 503), thereby selectively directing airflow to first branch 750 and/or second branch 760. In still other configurations not shown, the air flow to duct 745 can be controlled via a single air scoop 502, but the direction of the airflow can be controlled via a valve (e.g., valve 715) as similarly described with reference to FIGS. 7 and 8 above. It should be understood that, although the illustrations above discuss air scoop 503 as only permitting air flow when open, some embodiments may be configured to allow air flow to one or more of the components (e.g., to region of low pressure 220) when closed.

As with the embodiments described above, movement and positioning of the air scoop (and in some embodiments, valve 715) can be controlled and directed by a system controller, which in turn can be in communication with an intelligent agent. The intelligent agent can be located within the vehicle 100 or external to the vehicle 100. In various embodiments, the system control can determine a position of the valve 715 based on input data from one or more sensors (not shown). Exemplary sensors can comprise, but are not limited to, pressure sensors located at any exterior point on the vehicle 100 or within the first or second duct 405, 605 or wheel well 425, temperature sensors in the brakes 410, ambient temperature sensors, speed sensors, throttle position sensors, and the like.

One or more temperature sensors may be implemented in some embodiments of this disclosure. A thermocouple may be placed in direct contact with some part of the brake system located in a wheel well. In one embodiment, this sensor is a thermocouple that is placed on a surface that is not in the direct path of any cooling air that may be introduced when the active air scoop 101 is deployed. By keeping the thermocouple out of the direct path of cooling air a more accurate thermal reading may be made. In other embodiments, a number of thermocouples are placed both on various vehicle brake components and on other thermal sources in the wheel well.

In another contemplated embodiment one or more IR sensors may be used to detect the temperature of individual components in the wheel well. An IR sensor may be placed in direct line of site with the brake rotor, brake caliper, brake line, or another brake part. The use of multiple IR detectors or a single IR detector that is mechanically targeted at multiple thermal points is also contemplated.

Additionally, brake system temperature may be modeled on existing vehicle inputs such as vehicle speed, brake pressure, brake force applied over a given time, and other similar vehicle data points. Known brake algorithms may be used to calculate the change in kinetic energy of the vehicle. The change in the kinetic energy of the vehicle over a given time may be used to calculate the amount of kinetic energy absorbed by the vehicle's brakes. Known algorithms may be used to estimate the temperature of a vehicle's brake system after it has absorbed a calculated amount of kinetic energy. As such, a vehicle's brake temperature may be estimated without directly measuring the temperature of a vehicles brake system.

In some embodiments, the active air scoops are managed independently. Thus, when the thermal components located in a wheel well do not need additional cooling, the active air scoop is not deployed. However, if cooling is needed by one more thermal components in a wheel well, then the active air scoop is deployed.

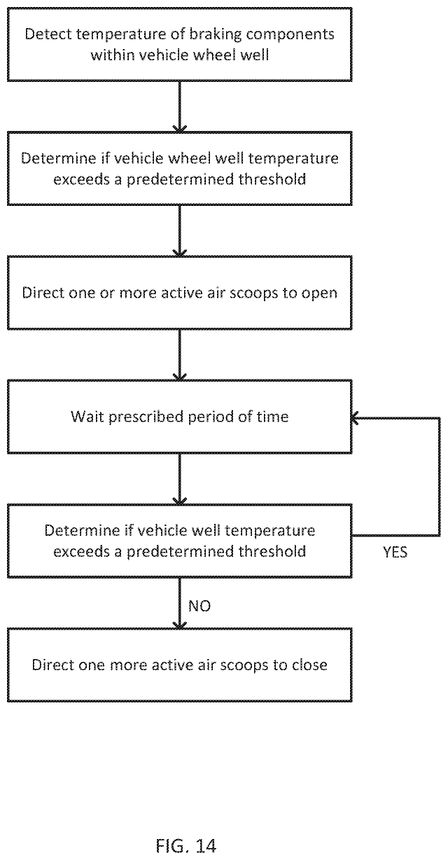

FIG. 14 depicts an exemplary intelligent predictive computer controlled cooling system process. This system is managed by a vehicle's master braking system. In one contemplated embodiment, a brake management system (not shown) is configured to control an actuator that controls one or more active air scoops 101. The brake management system may be further configured to receive input from one or more thermal detection devices located within a vehicle wheel well. The brake management system may be programed to compare the temperature reported by a thermal detection device with a programed thermal limit for a device or the wheel well environment. If the temperature reported by the thermal device exceeds that known thermal limit, then the brake management system may command the actuator to open one or more active air scoops.

It will be understood that the active air scoops may be opened fully or to a partial opened state depending on the commands from the brake management system. In one embodiment, the brake management system receives a thermal signal indicating the wheel well 103 temperature is above a thermal limit. The brake management system commands an actuator to open the active air scoop 101 associated with that wheel well to a half way open position. The brake management system then waits a prescribed period of time, which in some cases may be between 5 and 60 seconds. If the temperature in that wheel well is still above a thermal limit after the prescribed period has passed, then the brake management system may command an actuator to open the active air scoop to a fully open position. If the temperature in that wheel well falls below the thermal limit at any point, then the brake management system may command an actuator to close the active air scoop.

It will be understood by those skilled in the art that the brake management system described herein may be the vehicle's primary braking system or it may be a subsystem within a vehicle braking system. In other contemplated embodiments, the brake management system described herein as the control system for the active air scoops may be a separate system from the rest of the vehicle's braking system.

While the present disclosure has been described in connection with a series of preferred embodiments, these descriptions are not intended to limit the scope of the disclosure to the particular forms set forth herein. The above description is illustrative and not restrictive. Many variations of the embodiments will become apparent to those of skill in the art upon review of this disclosure. The scope of this disclosure should, therefore, be determined not with reference to the above description, but instead should be determined with reference to the appended claims along with their full scope of equivalents.

As used herein, the term “vehicle” refers to any land vehicle, motorized, electric, and hybrid. It also includes all vehicle types, including sedans, sports cars, station wagons, sports utility vehicles, trucks, vans, and tractor trailers.

As used herein, the terms “retracted” and/or “retractable” in conjunction with the ability for an airflow guiding piece to move, refer to a motion of retrieving the guiding piece back toward the vehicle's underbody, as opposed to moving away from the vehicle and toward the ground. It should be noted that these terms do not define how the guiding pieces are retrieved, and they do not define in what direction the guiding pieces are retrieved. For example, to “retract” an active air scoop, the motion can include pivoting the active air scoop in almost a rotating action along a longitudinal side of the side skirt. Likewise, to “retract” a side skirt can also include the motion of lifting the side skirt in a vertical direction toward the underbody without rotating the side skirt along its longitudinal side.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

What is claimed is:

1. An air duct system for a vehicle, comprising:
a channel capable of directing a flow of air;
an inlet defining a first end of the channel;
a first branch extending from the channel and terminating at a first outlet;
a second branch extending from the channel and terminating at a second outlet;
an active air scoop positioned at the inlet and configured to control an amount of air flow to the inlet.

2. The air duct system of claim 1, further comprising a second active air scoop, wherein
the active air scoop is configured to control a first amount of air flow to the first branch, and
the second active air scoop is configured to control a second amount of air flow to the second branch.

3. The air duct system of claim 1, wherein:
the active air scoop is configured to open and close at a plurality of positions;
the active air scoop is configured to control a first amount of air flow to the first branch and a second amount of air flow to the second branch based on the plurality of positions of the active air scoop.

4. The air duct system of claim 3, wherein:
at least a portion of the first branch is positioned above the second branch,
at a first position of the plurality of positions of the active air scoop, the first amount of air flow to the first branch is less than the second amount of air flow to the second branch, and
at a second position of the plurality of positions of the active air scoop, the first amount of air flow is greater than or equal to the second amount of air flow.

5. The air duct system of claim 3, wherein
the plurality of positions of the active air scoop include a first position wherein a first side of the active air scoop is more open than a second side of the active air scoop.

6. The air duct system of claim 3, wherein the first outlet directs air to a low-pressure region of the vehicle, and the second outlet directs air to brake components of the vehicle.

7. The air duct system of claim 1, wherein the active air scoop is positioned at an underbody of the vehicle such that when the active air scoop is in a closed position, a surface of the active air scoop is flush with a surface of the underbody of the vehicle.

8. The air duct system of claim 7, wherein the active air scoop is further configured to allow air flow to the first outlet and not the second outlet when the active air scoop is in the closed position.

9. The air duct system of claim 8, wherein the first outlet directs air to a low-pressure region of the vehicle.

10. The air duct system of claim 3 further comprising one or more sensors and a controller, wherein
the plurality of positions of the active air scoop are controlled by the controller based on data from the one or more sensors.

11. The air duct system of claim 1, further comprising a valve configured to be moved to a plurality of positions, wherein
the valve is positioned in the channel between the inlet and the first and second branch, and the valve is configured to control a first amount of air flow to the first branch and a second amount of air flow to the second branch based on the plurality of positions of the valve.

12. The air duct system of claim 11 further comprising one or more sensors and a controller, wherein
the plurality of positions of the valve are controlled by the controller based on data from the one or more sensors.

13. An active cooling system for a vehicle comprising:
an air duct capable of directing a flow of air to a wheel well of the vehicle;
an active air scoop positioned in front of the wheel well and hinged at a pivot point located on a side of the active air scoop nearest to the wheel well, wherein the active air scoop is configured to control an amount of air flow to the air duct;
a thermal sensing system configured to determine the temperature of at least one zone within the wheel well; wherein the active air scoop is controlled based on data from the thermal sensing system.

14. The active cooling system of claim 13, further comprising one or more actuators connected to the active air scoop, wherein
the one or more actuators are configured to move the active air scoop to a plurality of positions including a first closed position and a second open position.

15. The active cooling system of claim 13, further comprising:
a second active air scoop positioned in front of a second wheel well of the vehicle, the second wheel well being on a side of the vehicle opposite the wheel well, wherein
the thermal sensing system is further configured to determine the temperature of at least one zone within the second wheel well, and
the second active air scoop is controlled based on data from the thermal sensing system.

16. The active cooling system of claim 13, wherein
the air duct comprises:
a channel capable of directing the flow of air;
an inlet defining a first end of the channel,
a first branch extending from the channel and terminating at a first outlet;
a second branch extending from the channel and terminating at a second outlet.

17. The active cooling system of claim 16 further comprising a second active air scoop, wherein
the active air scoop is configured to control a first amount of air flow to the first branch, and
the second active air scoop is configured to control a second amount of air flow to the second branch.

18. The active cooling system of claim 16, wherein:
the plurality of positions of the active air scoop further includes a third position and a fourth position; and
at the third position of the plurality of positions of the active air scoop, the first amount of air flow to the first branch is less than the second amount of air flow to the second branch, and
at the fourth position of the plurality of positions of the active air scoop, the first amount of air flow is greater than or equal to the second amount of air flow.

19. The active cooling system of claim 18, wherein:
at least a portion of the first branch is positioned above the second branch,

20. The active cooling system of claim 16, wherein the first outlet directs air to a low-pressure region of the vehicle, and the second outlet directs air to brake components of the vehicle.
